(19) United States
(12) Patent Application Publication
(10) Pub. No.: US 2025/0050600 A1
(43) Pub. Date: Feb. 13, 2025

(54) Base Material For Waterproof Wall And Floor And Preparation Method Therefor

(71) Applicants: Anhui Yangzi Flooring Incorporated Company, Chuzhou, Anhui (CN); Anhui Yangzi Meija New Material Technology Co., Ltd, Chuzhou, Anhui (CN)

(72) Inventor: Xiang Lei, Chuzhou, Anhui (CN)

(73) Assignees: Anhui Yangzi Flooring Incorporated Company, Chuzhou, Anhui (CN); Anhui Yangzi Meija New Material Technology Co., Ltd, Chuzhou, Anhui (CN)

(21) Appl. No.: 18/562,458

(22) PCT Filed: Mar. 13, 2023
(86) PCT No.: PCT/CN2023/081011

§ 371 Date: Nov. 20, 2023

(30) Foreign Application Priority Data
Dec. 8, 2022 (CN) 202211573363.5

(51) Int. Cl. B29D 7/01; C08G 18/38; C08G 18/44; C08G 18/48; C08G 18/61; C08G 18/66; E04F 13/077

(52) U.S. Cl. CPC B29D 7/01; C08G 18/38; C08G 18/44; C08G 18/48; C08G 18/61; C08G 18/66; E04F 13/077

(57) ABSTRACT

The present invention relates to the field of plates, and discloses a base material for a waterproof wall and floor and a preparation method therefor, belonging to the technical field of plates. The base material comprises a base plate and melamine decorative paper, and the base plate and the melamine decorative paper are bonded by an adhesive; and the preparation method comprises the following steps: step 1: preparing a base plate, and step 2: coating 10 an adhesive on a surface of the base plate, then attaching the melamine decorative paper, and placing for 3 days at a temperature of 20° C. to obtain the base material for the waterproof wall and floor.

### CROSS-REFERENCE TO RELATED APPLICATIONS

The present application is a U.S. National entry under 35 U.S.C. § 371 of International Application No. PCT/CN2023/081011, filed Mar. 13, 2023, which claims the benefit of, and priority to Chinese Patent Application No. 202211573363.5 filed on Dec. 8, 2022 in the China National Intellectual Property Administration, the disclosures of which are hereby incorporated by reference in its entirety.

### TECHNICAL FIELD

The present invention belongs to the technical field of plates, and specifically relates to a base material for a waterproof wall and floor and a preparation method therefor.

### BACKGROUND

Wooden plates are comfortable to touch, but are prone to swelling due to water absorption or deformation due to drying. During use, problems such as shrinkage, swelling, deformation, warping, and cracking often occur. In addition, a large amount of wood is consumed, the production cycle is long, and the cost is high. The waste circuit board is a mixture of glass fiber reinforced resin and various metals, belongs to typical electronic waste and can be used as a raw material for plates. If not properly treated and disposed, the waste circuit board will not only cause a massive loss of useful resources, but also cause serious harm to the environment. Materials such as resin and glass fiber in the waste circuit board are difficult to degrade and will cause pollution to groundwater sources and soil. At the same time, the conventional methods of stacking or landfilling occupy a large amount of space. Moreover, the heavy metals contained in the waste circuit board, such as mercury, chromium, cadmium and other high-molecular organic matter, are difficult to degrade under natural conditions, and harmful components will enter the environment through water, atmosphere, and soil, which will cause potential, long-term, and irreversible harm to human health and the ecological environment. The waste printed circuit board contains raw materials that can be used as plate materials, and therefore become materials that can be recycled. This is conducive to environmental protection and the development and utilization of potential resources, and can create certain economic benefits.

### Technical Problems

The existing wooden plate is prone to swelling due to water absorption or deformation due to drying. During use, problems such as shrinkage, swelling, deformation, warping, and cracking often occur. The waste circuit board is a mixture of glass fiber reinforced resin and various metals and belongs to typical electronic waste. If not properly treated and disposed, the waste circuit board will not only cause a massive loss of useful resources, but also cause serious harm to the environment.

To solve the above problems, an objective of the present invention is to provide a base material for a waterproof wall and floor and a preparation method therefor.

### Technical Solutions

The objective of the present invention can be achieved by the following technical solutions:

A base material for a waterproof wall and floor comprises: a base plate and melamine decorative paper, wherein the base plate and the melamine decorative paper are bonded by an adhesive; and
the base plate is prepared by the following steps:
step 1: pretreatment of a waste circuit board: extracting glass fiber cloth from the waste circuit board, then crushing the circuit board, extracting metal, drying the remaining circuit board powder under a temperature of 100° C., wherein a moisture content is less than 3% by vacuum drying, and taking the extracted glass fiber cloth and the dried circuit board powder as raw materials;
step 2: performing hot melting and wire drawing on the glass fiber cloth to prepare a fiber net; mixing the circuit board powder and a sizing agent, then paving the mixture layer by layer with the fiber net, prepressing the mixture, and then hot-pressing the mixture to form the base plate.

The adhesive is prepared by the following steps:
after mixing modified cardanol, polyether polyol, hydroxyl-terminated branched polysiloxane and a molecular sieve, dehydrating the mixture at a temperature of 110-120° C. under a vacuum condition until a moisture content is less than 1000 ppm to obtain a component A; mixing isocyanate, polyether polyol, polyester polyol and a chain extender, stirring and reacting at a temperature of 85-90° C., and controlling a content of NCO % to be 15-20% to obtain a component B; and mixing the component A and the component B to obtain an adhesive.

Further, in the step 2, a mass ratio of an amount of the circuit board powder to an amount of the sizing agent is 8-9:100.

Further, a mass ratio of the component A to the component B is 3:1.

Further, the isocyanate is one of toluene diisocyanate and isophorone diisocyanate, the polyether polyol is one of polytetrahydrofuran glycol and poly(propylene glycol), the polyester polyol is polycarbonate diol, and the chain extender is 1,2-ethylene glycol.

Further, the hydroxyl-terminated branched polysiloxane is prepared by the following steps:
under the protection of nitrogen and at a temperature of 20° C., mixing tetraethoxysilane, 1,4-butanediol and p-toluenesulfonic acid, and heating the mixture for reaction, wherein the distillation temperature is controlled below 78° C. during this period; and keeping the temperature when a reaction temperature reaches 160° C., and stopping the heating until a distillation temperature is reduced to 55° C. to obtain the hydroxyl-terminated branched polysiloxane, wherein an amount ratio of tetraethoxysilane to 1,4-butanediol to p-toluenesulfonic acid is 23 g: 36 g: 100 mg. The hydroxyl-terminated branched polysiloxane is a polymer mainly composed of Si—O—Si bonds, which has excellent heat resistance, toughness, acid and alkali resistance, weather resistance, hydrophobicity and insulation. As the raw material in component A, the hydroxyl-terminated branched polysiloxane reacts with the ingredients in component B to introduce Si—O—Si chain segments into the structure of the adhesive, which improves the stability of the adhesive, so that the dimensional stability of the product is better improved.

Further, the modified cardanol is prepared by the following steps:
under the protection of nitrogen, adding 6,6,6-trifluoro-1-iodohexane, sodium bicarbonate, cardanol and sodium dithionite into acetonitrile, and heating and refluxing for reaction for 3 h, adding water and diethyl ether for extraction after the reaction is completed, reserving an organic phase, drying by anhydrous magnesium sulfate, and obtaining an intermediate product after concentrated under reduced pressure; wherein an amount ratio of 6,6,6-trifluoro-1-iodohexane to sodium bicarbonate to cardanol to sodium dithionite to acetonitrile is 0.1 mol: 0.02 mol: 0.1 mol: 0.1 mol: 200 mL; the 6,6,6-trifluoro-1-iodohexane and cardanol are used as raw materials, a trifluoro group is introduced into a structure of the cardanol, wherein fluorine has a low surface energy and is a hydrophobic atom, and the fluorine-containing chain segment can migrate to the surface, so that the fluorine on the surface of the material is aggregated, and the water resistance is enhanced;
adding the intermediate product, mercaptoethanol and a photoinitiator 2-hydroxy-2-methylpropiophenone into ethyl acetate; stirring and reacting the mixture for 10 h under the irradiation of ultraviolet light; after the reaction is completed, adding a saturated aqueous sodium chloride solution into a reaction system for washing; and after the washing is completed, performing concentration under reduced pressure on the obtained organic phase to remove a solvent, and obtaining the modified cardanol. An amount ratio of the intermediate product to mercaptoethanol to 2-hydroxy-2-methylpropiophenone to ethyl acetate is 3.5 g: 3 g: 100 mg: 30 mL. After introducing fluorine-containing elements through 6,6,6-trifluoro-1-iodohexane, a hydroxyl group is introduced into a structure of cardanol by a “mercapto-ene” light click reaction, and then the adhesive is prepared by taking the modified cardanol as a raw material.

Further, the fiber net in the base plate has a mesh of 2-6 cm.

Further, the hot-pressing is performed at a temperature of 70-80° C., the pressing is performed for 2.5-4 min/mm plate thickness, and a surface pressure is 35-40 Kg/cm².

Further, the component A comprises 20-22 parts by weight of modified cardanol, 15-18 parts by weight of polyether polyol, 8-10 parts by weight of hydroxyl-terminated branched polysiloxane, and 8-10 parts by weight of molecular sieve; and the component B comprises 70-80 parts by weight of isocyanate, 8-10 parts by weight of polyether polyol, 10-30 parts by weight of polyester polyol, and 2-3 parts by weight of chain extender.

A preparation method for the base material for a waterproof wall and floor comprises the following steps:
step 1: preparing a base plate; and
step 2: coating an adhesive on a surface of the base plate, then attaching the melamine decorative paper, and placing for 3 days at a temperature of 20° C. to obtain the base material for the waterproof wall and floor.

### Beneficial Effects

In the conventional technology, materials such as wood chips and adhesives are mixed and extruded to form plates, however, the wood is prone to absorb water and deform, the formed composite plate can release formaldehyde and the like, which will cause harm to the human body and is relatively poor in environmental protection. To relieve the problems, in the present invention, the waste circuit board is treated, and the extracted glass fiber cloth and dried circuit board powder are used as raw materials to cooperate with a self-made adhesive to prepare a base plate. Compared with the wooden plate, the base plate in the present invention has better water resistance, less natural deformation, better nail resistance and use strength. Meanwhile, the adhesive used in a cooperative mode belongs to a solvent-free double-component polyurethane adhesive, which is environmentally friendly, the adhesive and the base plate cooperate with each other to better meet the use requirement, and the water absorption rate of the base plate is less than 0.2% after testing.

### EMBODIMENTS OF THE PRESENT INVENTION

The following clearly and completely describes the technical solutions in embodiments of the present invention with reference to embodiments of the present invention. It is clear that the described embodiments are merely a part rather than all of embodiments of the present invention. All other embodiments obtained by those of ordinary skill in the art based on embodiments of the present invention without creative efforts shall fall within the protection scope of the present invention.

A base material for a waterproof wall and floor comprises: a base plate and melamine decorative paper, wherein the base plate and the melamine decorative paper are bonded by an adhesive; and a preparation method for the base material for a waterproof wall and floor comprises the following steps:
step 1: preparing a base plate; and
step 2: coating an adhesive on a surface of the base plate, then attaching the melamine decorative paper, and placing for 3 days at a temperature of 20° C. to obtain the base material for the waterproof wall and floor.

### Example 1

### Preparation of Modified Cardanol:

under the protection of nitrogen, adding 6,6,6-trifluoro-1-iodohexane, sodium bicarbonate, cardanol and sodium dithionite into acetonitrile, and heating and refluxing for reaction for 3 h, adding water and diethyl ether for extraction after the reaction is completed, reserving an organic phase, drying by anhydrous magnesium sulfate, and obtaining an intermediate product after concentrated under reduced pressure; wherein an amount ratio of 6,6,6-trifluoro-1-iodohexane to sodium bicarbonate to cardanol to sodium dithionite to acetonitrile is 0.1 mol: 0.02 mol: 0.1 mol: 0.1 mol: 200 mL;
adding the intermediate product, mercaptoethanol and a photoinitiator 2-hydroxy-2-methylpropiophenone into ethyl acetate; stirring and reacting the mixture for 10 h under the irradiation of ultraviolet light; after the reaction is completed, adding a saturated aqueous sodium chloride solution into a reaction system for washing; and after the washing is completed, performing concentration under reduced pressure on the obtained organic phase to remove a solvent, and obtaining the modified cardanol. An amount ratio of the intermediate product to mercaptoethanol to 2-hydroxy-2-methylpropiophenone to ethyl acetate is 3.5 g: 3 g: 100 mg: 30 mL.

### Example 2

### Preparation of Hydroxyl-Terminated Branched Polysiloxane:

under the protection of nitrogen and at a temperature of 20° C., mixing tetraethoxysilane, 1,4-butanediol and p-toluenesulfonic acid, and heating the mixture for reaction, wherein the distillation temperature is controlled below 78° C. during this period; and keeping the temperature when a reaction temperature reaches 160° C., and stopping the heating until a distillation temperature is reduced to 55° C. to obtain the hydroxyl-terminated branched polysiloxane, wherein an amount ratio of tetraethoxysilane to 1,4-butanediol to p-toluenesulfonic acid is 23 g: 36 g: 100 mg.

### Example 3

### Preparation of a Base Plate:

step 1: pretreatment of a waste circuit board: extracting glass fiber cloth from the waste circuit board, then crushing the circuit board, extracting metal, drying the remaining circuit board powder under a temperature of 100° C., wherein a moisture content is less than 3% by vacuum drying, and taking the extracted glass fiber cloth and the dried circuit board powder as raw materials;
step 2: mixing 20 parts of modified cardanol prepared in Example 1, 15 parts of poly(propylene glycol), 8 parts of hydroxyl-terminated branched polysiloxane prepared in example 2 and 8 parts of molecular sieve, and dehydrating at 110° C. under vacuum condition until the moisture content is less than 1000 ppm to obtain a component A; mixing 70 parts of isophorone diisocyanate, 8 parts of polytetrahydrofuran glycol, 10 parts of polycarbonate diol and 2 parts of 1,2-ethylene glycol, stirring and reacting at 85° C., and controlling a content of NCO % to be 15% to obtain a component B; and mixing the component A and the component B in a mass ratio of 3:1 to obtain an adhesive; performing hot melting and wire drawing on the glass fiber cloth to prepare a fiber net, wherein the fiber net has a mesh of 2-6 cm; mixing the circuit board powder and a sizing agent, then paving the mixture layer by layer with the fiber net, prepressing the mixture, and then hot-pressing the mixture to form the base plate. A mass ratio of an amount of the circuit board powder to an amount of the sizing agent is 8:100. The hot-pressing is performed at a temperature of 70° C., the pressing is performed for 2.5 min/mm plate thickness, and a surface pressure is 35 Kg/cm².

### Example 4

### Preparation of a Base Plate:

step 1: pretreatment of a waste circuit board: extracting glass fiber cloth from the waste circuit board, then crushing the circuit board, extracting metal, drying the remaining circuit board powder under a temperature of 100° C., wherein a moisture content is less than 3% by vacuum drying, and taking the extracted glass fiber cloth and the dried circuit board powder as raw materials;
step 2: mixing 22 parts of modified cardanol prepared in Example 1, 18 parts of poly(propylene glycol), 10 parts of hydroxyl-terminated branched polysiloxane prepared in example 2 and 10 parts of molecular sieve, and dehydrating at 120° C. under vacuum condition until the moisture content is less than 1000 ppm to obtain a component A; mixing 80 parts of isophorone diisocyanate, 10 parts of polytetrahydrofuran glycol, 30 parts of polycarbonate diol and 3 parts of 1,2-ethylene glycol, stirring and reacting at 85° C., and controlling a content of NCO % to be 18% to obtain a component B; and mixing the component A and the component B in a mass ratio of 3:1 to obtain an adhesive; performing hot melting and wire drawing on the glass fiber cloth to prepare a fiber net, wherein the fiber net has a mesh of 2-6 cm; mixing the circuit board powder and a sizing agent, then paving the mixture layer by layer with the fiber net, prepressing the mixture, and then hot-pressing the mixture to form the base plate. A mass ratio of an amount of the circuit board powder to an amount of the sizing agent is 9:100. The hot-pressing is performed at a temperature of 80° C., the pressing is performed for 3 min/mm plate thickness, and a surface pressure is 40 Kg/cm².

### Example 5

### Preparation of a Base Plate:

step 1: pretreatment of a waste circuit board: extracting glass fiber cloth from the waste circuit board, then crushing the circuit board, extracting metal, drying the remaining circuit board powder under a temperature of 100° C., wherein a moisture content is less than 3% by vacuum drying, and taking the extracted glass fiber cloth and the dried circuit board powder as raw materials;
step 2: mixing 22 parts of modified cardanol prepared in Example 1, 18 parts of poly(propylene glycol), 10 parts of hydroxyl-terminated branched polysiloxane prepared in example 2 and 10 parts of molecular sieve, and dehydrating at 120° C. under vacuum condition until the moisture content is less than 1000 ppm to obtain a component A; mixing 80 parts of isophorone diisocyanate, 10 parts of polytetrahydrofuran glycol, 30 parts of polycarbonate diol and 3 parts of 1,2-ethylene glycol, stirring and reacting at 90° C., and controlling a content of NCO % to be 20% to obtain a component B; and mixing the component A and the component B in a mass ratio of 3:1 to obtain an adhesive; performing hot melting and wire drawing on the glass fiber cloth to prepare a fiber net, wherein the fiber net has a mesh of 2-6 cm; mixing the circuit board powder and a sizing agent, then paving the mixture layer by layer with the fiber net, prepressing the mixture, and then hot-pressing the mixture to form the base plate. A mass ratio of an amount of the circuit board powder to an amount of the sizing agent is 9:100. The hot-pressing is performed at a temperature of 80° C., the pressing is performed for 4 min/mm plate thickness, and a surface pressure is 40 Kg/cm².

### Comparative Example 1

Compared with Example 5, in this comparative example, the hydroxyl-terminated branched polysiloxane is replaced with polyether polyol that is polytetrahydrofuran glycol, and the remaining raw materials and the preparation process are the same as those in Example 5.

The performance tests were performed on Examples 3 to 5 and Comparative Example 1, and the water absorption swelling rate: (1) a test sample had a length of 150±1 mm and a width of 50±1 mm, and 2 test samples were provided, wherein one test sample was along a length direction, and the other piece was along a width direction; (2) a thickness at 6 points along edges of the sample was measured; and (3) the sample was immersed in water for 24±15 min (with a pH value of 7±1 and at a temperature of 20±1° C.).

The high temperature and high humidity refers to boiling for 2 h at a temperature of 95° C.

Wear-resistance in surface: (1) a test sample had a length of 100±0.5 mm and a width of 100±0.5 mm, 3 test samples were provided, and the sample was divided into four quadrants along the diagonal; (2) a sandpaper had a grain width P of 180 and a load of 4.9±0.1 N, and the sandpaper was changed after 500 revolutions until obvious damage points appeared in three quadrants of the sample, and final revolutions were recorded.

The results are shown in Table 1:

TABLE 1

| | | | | Comparative |
|---|---|---|---|---|
| Item | Example 3 | Example 4 | Example 5 | Example 1 |
| Water absorption | ≤0.2 | ≤0.2 | ≤0.2 | ≤10 |
| swelling rate/% | | | | |
| High temperature and | No significant | No significant | No significant | Denatured |
| high humidity | change | change | change | |
| | Normal splicing | Normal splicing | Normal splicing | |
| Wear-resistance in | ≥9000 | ≥9000 | ≥9000 | ≥6000 |
| surface | | | | |

It can be seen from Table 1 that the base plate in the base material for a waterproof wall and floor prepared by the present invention has good high temperature resistance, high humidity resistance, water resistance and moisture resistance, has good wear resistance, and can meet more requirements.

It should be noted that, in the present invention, relational terms such as “first” and “second” are merely used to distinguish one entity or operation from another entity or operation without necessarily requiring or implying any actual relationship or order between such entities or operations. Moreover, terms “include”, “comprise”, or any other variants thereof are intended to cover a non-exclusive inclusion, so that a process, a method, an article, or a device that includes a list of elements includes those elements, and also includes other elements which are not expressly listed, or further includes elements inherent to this process, method, article, or device.

Although the embodiments of the present invention have been shown and described, it will be understood by those of ordinary skill in the art that various changes, modifications, substitutions and alterations may be made to these embodiments without departing from the principle and spirit of the present invention, and the scope of the present invention is defined in the appended claims and equivalents thereof.

### INDUSTRIAL APPLICABILITY

According to the present invention, the waste circuit board is treated, and the extracted glass fiber cloth and dried circuit board powder are used as raw materials to cooperate with a self-made adhesive to prepare a base plate. Compared with the wooden plate, the base plate in the present invention has better water resistance, less natural deformation, better nail resistance and use strength. Meanwhile, the adhesive used in a cooperative mode belongs to a solvent-free double-component polyurethane adhesive, which is environmentally friendly, the adhesive and the base plate cooperate with each other to better meet the use requirement, and the water absorption rate of the base plate is less than 0.2% after testing, so that the base plate has good industrial practicability.

1. A base material for a waterproof wall and floor, comprising: a base plate and melamine decorative paper, wherein the base plate and the melamine decorative paper are bonded by an adhesive, and the base plate is prepared by the following steps:
step 1: pretreatment of a waste circuit board: taking an extracted glass fiber cloth and dried circuit board powder as raw materials;
step 2: after mixing modified cardanol, polyether polyol, hydroxyl-terminated branched polysiloxane and a molecular sieve, dehydrating the mixture at a temperature of 110-120° C. under a vacuum condition until a moisture content is less than 1000 ppm to obtain a component A; mixing isocyanate, polyether polyol, polyester polyol and a chain extender, stirring and reacting at a temperature of 85-90° C., and controlling a content of NCO % to be 15-20% to obtain a component B; mixing the component A and the component B to obtain an adhesive; performing hot melting and wire drawing on the glass fiber cloth to prepare a fiber net; mixing the circuit board powder and a sizing agent, then paving the mixture layer by layer with the fiber net, prepressing the mixture, and then hot-pressing the mixture to form the base plate.

2. The base material for a waterproof wall and floor according to claim 1, wherein in the step 2, a mass ratio of the component A to the component B is 3:1; and a mass ratio of an amount of the circuit board powder to an amount of the sizing agent is 8-9:100.

3. The base material for a waterproof wall and floor according to claim 1, wherein the isocyanate is one of toluene diisocyanate and isophorone diisocyanate, the polyether polyol is one of polytetrahydrofuran glycol and poly(propylene glycol), the polyester polyol is polycarbonate diol, and the chain extender is 1,2-ethylene glycol.

4. The base material for a waterproof wall and floor according to claim 1, wherein the hydroxyl-terminated branched polysiloxane is prepared by the following steps:
under the protection of nitrogen and at a temperature of 20° C., mixing tetraethoxysilane, 1,4-butanediol and p-toluenesulfonic acid, heating the mixture for reaction, keeping the temperature when a reaction temperature reaches 160° C., and stopping the heating until a distillation temperature is reduced to 55° C. to obtain the hydroxyl-terminated branched polysiloxane.

5. The base material for a waterproof wall and floor according to claim 1, wherein the modified cardanol is prepared by the following steps:
under the protection of nitrogen, adding 6,6,6-trifluoro-1-iodohexane, sodium bicarbonate, cardanol and sodium dithionite into acetonitrile, and heating and refluxing for reaction for 3 h to obtain an intermediate product; and adding the intermediate product, mercaptoethanol and a photoinitiator 2-hydroxy-2-methylpropiophenone into ethyl acetate, and stirring and reacting for 10 h under the irradiation of ultraviolet light to obtain the modified cardanol.

6. The base material for a waterproof wall and floor according to claim 1, wherein the fiber net in the base plate has a mesh of 2-6 cm.

7. The base material for a waterproof wall and floor according to claim 1, wherein the hot-pressing is performed at a temperature of 70-80° C., the pressing is performed for 2.5-4 min/mm plate thickness, and a surface pressure is 35-40 Kg/cm².

8. The base material for a waterproof wall and floor according to claim 1, wherein the component A comprises 20-22 parts by weight of modified cardanol, 15-18 parts by weight of polyether polyol, 8-10 parts by weight of hydroxyl-terminated branched polysiloxane, and 8-10 parts by weight of molecular sieve; and the component B comprises 70-80 parts by weight of isocyanate, 8-10 parts by weight of polyether polyol, 10-30 parts by weight of polyester polyol, and 2-3 parts by weight of chain extender.

9. A preparation method for the base material for a waterproof wall and floor according to claim 1, comprising the following steps:
step 1: preparing a base plate; and
step 2: coating an adhesive on a surface of the base plate, then attaching the melamine decorative paper, and placing for 3 days at a temperature of 20° C. to obtain the base material for the waterproof wall and floor.
